(19) United States
(12) Patent Application Publication
(10) Pub. No.: US 2014/0014581 A1
(43) Pub. Date: Jan. 16, 2014

(54) Systems and Methods for Reducing Fouling in a Filtration System

(71) Applicant: World Wide Water Solutions, Gilbert, AZ (US)

(72) Inventor: Dennis Chancellor, Gilbert, AZ (US)

(21) Appl. No.: 14/025,381

(22) Filed: Sep. 12, 2013

Related U.S. Application Data
(63) Continuation-in-part of application No. 13/835,922, filed on Mar. 15, 2013, now abandoned.
Application No. 13/835,922 is a continuation-in-part of application No. 13/804,166, filed on Mar. 14, 2013.
(60) Provisional application No. 61/622,932, filed on Apr. 11, 2012.
(60) Provisional application No. 61/680,632, filed on Aug. 7, 2012.

(51) Int. Cl. B01D 65/08

(52) U.S. Cl. CPC B01D 65/08
USPC 210/636; 210/321.69; 210/321.66

(57) ABSTRACT

A filtration system include a vessel and a filter element, a first port through which a feed stream can enter the vessel, a second port through which a reject stream can exit the vessel, and a third port through which a permeate can exit the vessel, and a valve system that can be configured to alternately pass the feed stream into the vessel through the first and second ports.

This application in a continuation in part of U.S. utility application Ser. No. 13/835,922 filed Mar. 15, 2013, which claims priority to U.S. provisional application Ser. No. 61/622,932 filed Apr. 11, 2012. U.S. Ser. No. 13/835,922 is also a continuation in part of U.S. utility application Ser. No. 13/804,166 filed Mar. 14, 2013, which claims priority to U.S. provisional application Ser. No. 61/680,632 filed Aug. 7, 2012.

### FIELD OF THE INVENTION

The field of the invention is filtration systems and methods.

### BACKGROUND

Numerous fluids of commercial import include solids and other components that need to be removed prior to use. Such fluids include water for municipal consumption, waste water (which may require removal of toxic contaminants prior to disposal), and process streams from various industrial processes. Towards that end a variety of physical and chemical filtration techniques have been developed to remove such components, and thereby produce purified fluids that are suitable for use.

Filtration methods based on the application of crude fluids to a filter (e.g. a filter bed or filter membrane) generally experience a build up of contaminants at the filter surface over time. This build-up, known as fouling, occurs when contaminants in the unprocessed fluid enter the pores or other interstices of the filter and form a layer on its outer surface. Fouling reduces the porosity and available surface area of the filter, reducing filtration efficiency and the rate of production of the desired permeate fluid.

Filter fouling is of particular concern with respect to reverse osmosis (RO) and other nanofiltration filters because the pore size is so small. Typical RO filters utilize crossflow filtration, in which a flow of contaminated fluid is directed across an exterior surface of a spiral wound filter media or filter membrane, while a filtered permeate fluid is collected from the interior surface. A variety of methods have been used to reduce fouling of crossflow filters. Historically, application of the waste fluid at a high flow rate has been used to attempt to “sweep” the outer surface of the filter free of contaminants. However, this approach typically requires costly high flow, high pressure pumps, and reduces the rate of filtration to minimize the pressure difference across the filter. In addition, the filter must be taken “off line” to accomplish the sweep.

Another approach to reduce fouling uses a pump to direct a backflush fluid in a reverse direction through the filter element, thus displacing contaminants that have penetrated or imbedded into the filter media. In some embodiments that can include using an amount of the permeate as the backflush fluid. An exemplary system is described in U.S. Pat. No. 6,423,230 to Ilias et al. Unfortunately, in addition to the loss of permeate fluid, this approach can subject the filter membranes to stresses that can lead to membrane failure. While this leads to more efficient removal of surface fouling, however, it does not address the issue of permeation of contaminants into the filter membrane or filter bed.

All publications discussed herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods for reducing fouling within a filtration system.

### SUMMARY OF THE INVENTION

The inventive subject matter provides apparatus, systems, and methods in which a feed fluid is passed along an upstream surface of a filter member in alternating directions to help prevent fouling of the filter.

In preferred embodiments, the filter member comprises a spiral wound filter media about a collection tube. A wide variety of filter media are available, including fibers, porous membranes, and particulate beds. Desirable filter media often have features to increase their surface area, such as a high degree of porosity or the use of multiple layers of woven material, which increases filter efficiency but may do so at the cost of the filter material's mechanical stability.

Contemplated filter media can include, for example, sand, charcoal, paper, and other media, and any membrane capable of filtering a fluid. The filter media and assembly are preferably selected based on the commercial application and could be of any commercially suitable type, size or manufacturer. An especially preferred reverse osmosis filter includes a filter element and a casing formed about the filter element, such as those described in U.S. utility application titled “Water Purification System With Entrained Filtration Elements” having Ser. No. 13/263,819 filed on Oct. 10, 2011.

Contemplated filter members are typically enclosed within a vessel, with a first port through which a feed stream enters the vessel, a second port through which a reject stream exits the vessel, and a third port through which a permeate exits the vessel. In the case of an elongated spiral wound filter member, a portion of the feed stream passes through the filter member to become permeate, is collected in a permeate collection tube running axially along the center of the filter member, and exits as permeate through the third port.

In some instances the feed fluid passes axially along the outside of the filter member, between the filter member and the inner wall of the vessel.

Appropriate opening and closing of valves allows the feed fluid to enter the first port and exit the second port during some period of operation, and then enter the second port and exit the first port during some other period of operation. The switching in direction of the feed fluid can be accomplished at any desired regular or irregular intervals, such as for example daily, weekly or monthly. Cleaning may be initiated by a controller at a predetermined time or interval. Alternatively, a controller may initiate cleaning as needed based on data from a monitor. Such a monitor may characterize any parameter relevant to the performance of the crossflow filter, including, for example, permeate flow rate, pressure across the filter media, optical density of a contaminated fluid applied to the filter media, and any combination(s) thereof.

One huge advantage of the systems and methods discussed herein is that there need be little or no loss of feed fluid pressure against the filter element, and consequently there need be little or no down time for the system due to such switching. This is in sharp distinction with prior art purging systems that either use high pressure blasts of gas or liquids against the outside of the filter member, and also with prior art systems that force a permeate or other purging fluid back through the filter member in a reverse direction from that used in normal operation.

Various objects, features, aspects and advantages of the inventive subject matter will become more apparent from the following detailed description of preferred embodiments, along with the accompanying drawing figures in which like numerals represent like components. It should also be apparent that groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWINGS

FIGS. 1A-1B are schematics of one embodiment of a filtration system.

FIGS. 2A-2B are schematics of another embodiment of a filtration system.

FIG. 3 is a photograph of different fluid samples.

### DETAILED DESCRIPTION

The following discussion provides several example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

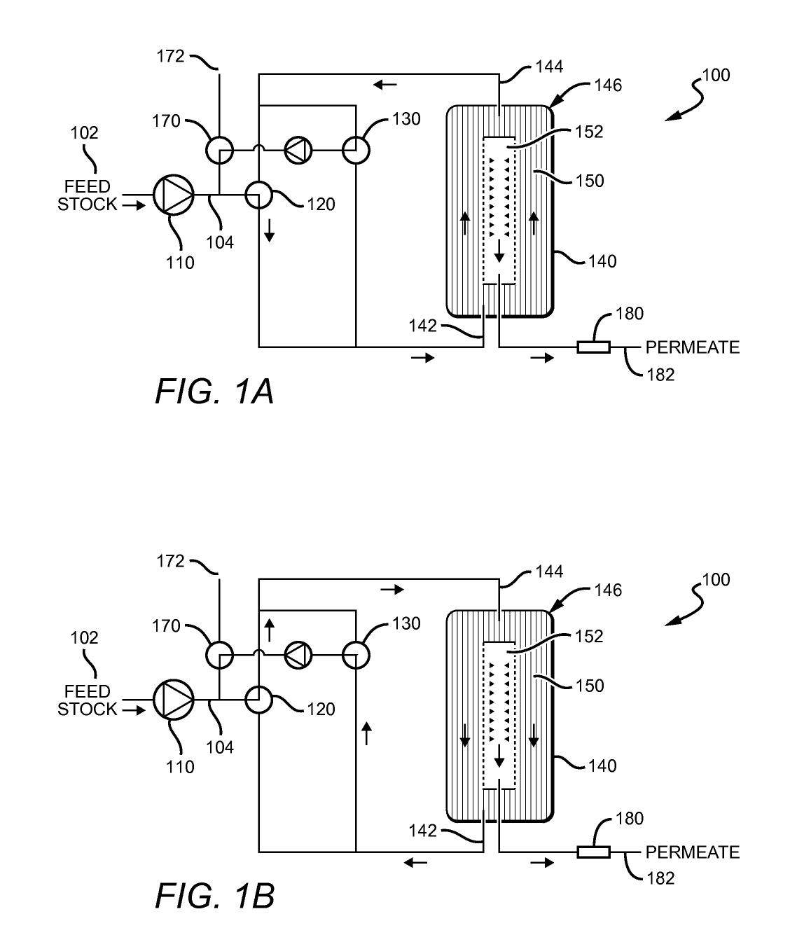

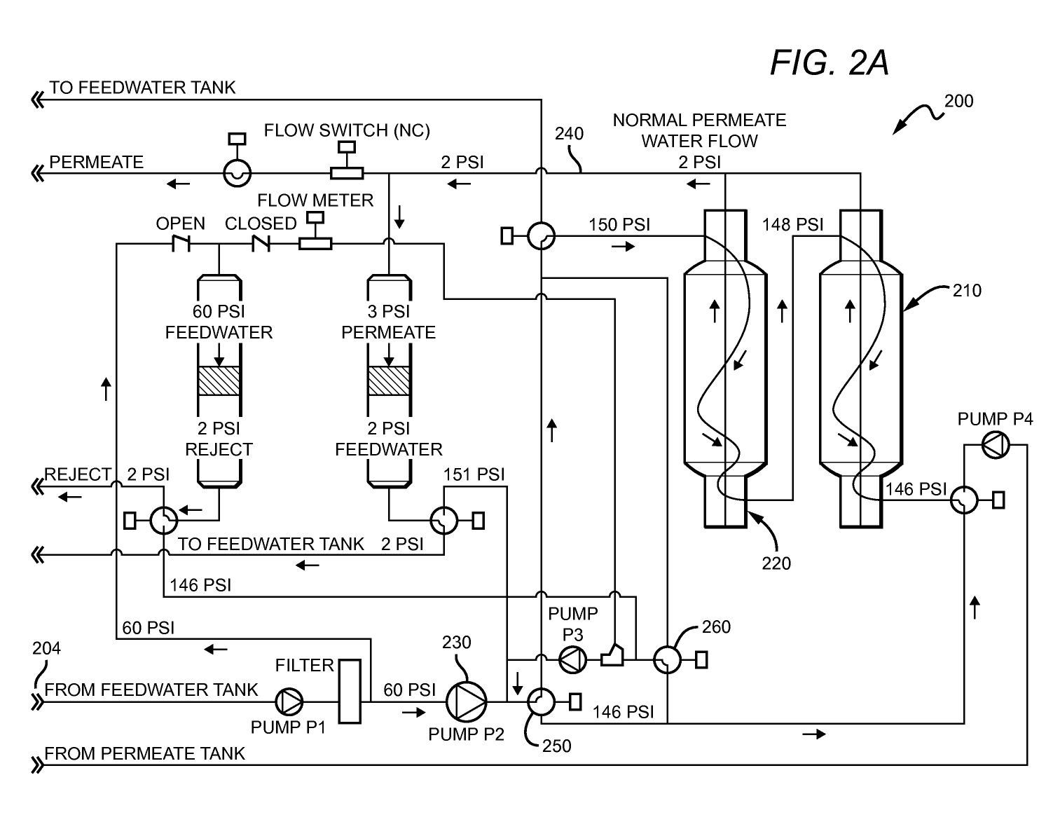

FIGS. 1A-1B illustrate one embodiment of a filtration system 100, where arrows indicate the direction of fluid flow. FIG. 1A shows an embodiment of the filtration system 100 during normal operation. A feed stock tank (not shown) or other fluid source supplies a feed fluid 102 to a pump 110, which generates a pressurized feedwater stream 104. At least a portion of stream 104 can be directed by valve 120 to an inlet port 142 of a filter 140, which preferably includes a pressure vessel 146 and a filter media 150. Within filter 140, a portion of the pressurized stream 104 can traverse filter media 150, and collect as a permeate stream within permeate collection tube 152. The permeate stream can then exit the filter 140 via permeate conduit 182. Waste fluid from filter 140 can exit the filter 140 via outlet port 144 of the filter 140 as a reject or flow-by stream.

It is contemplated that at least a portion of the reject stream can be directed by valves 130, 170 to be joined with pressurized stream 104 downstream of pump 110 for further processing by filter 140. Alternatively, some or all of the reject stream can be directed to a holding tank or other location via valve 170.

During the filtration process, contaminants from the pressurized feedwater stream 104 can accumulate on and thereby foul the filter media 150. In some embodiments, a flow sensor 180 or other fluid monitoring device may be used to monitor the flow rate of permeate through permeate conduit 182, which in turn can be used to determine if the filter media 150 requires cleaning. For example, should the flow rate of permeate decrease below a predefined threshold, which is likely dependent on the flow rate of the feedwater fluid 102, a controller or other device can be alerted that the permeate flow rate is below the desired level.

FIG. 1B illustrates system 100 in which the feed fluid flows along the upstream side of the filter 140 in a direction opposite to that described above (reverse flow). Here, a feed stock tank or other source (not shown) supplies feed fluid 102 to pump 110, which generates pressurized feedwater stream 104. During this opposite flow operation, valve 120 directs the pressurized stream 104 to the outlet port 144 of filter 140, providing a flow of material across the filter 140 that is in the reverse direction of that shown in FIG. 1A. This reverse flow can advantageously displace at least a portion of the contaminants fouling the surface of the filter media 150 into the waste fluid flowing past the filter assembly and exit inlet port 142.

FIGS. 1A and 1B should be interpreted to include, but not be limited to, embodiments in which the filter media is a spiral wound nanofiltration membrane.

FIGS. 1A and 1B should also be interpreted to include, but not be limited to, embodiments in which the vessel is formed about the filter element, as described in U.S. utility application Ser. No. 13/263,819, discussed above.

Optionally, a pressurized purge solution can be directed into the lumen at a pressure that is greater than that of the pressurized stream 104 surrounding the filter media 150. Such configuration advantageously permits precise control of the pressure differential between the permeate collection tube 152 and the surrounding waste fluid, thereby avoiding damage to the filter media 150. This advantageously can result in movement of purge solution from the permeate collection tube 152 through the filter media 150 and into the feed fluid flowing past the filter assembly 142, and displaces at least a portion of the fouling contaminants that have accumulated in the filter media 150. The contaminants and waste fluid can exit the filter 140 through inlet port 142. The crude fluid mixture carrying the displaced contaminants leaves the crossflow filter as a reject stream and can be directed to a waste area 172 by valve 170 or rejoined with pressurized stream 104 for further processing. Alternatively, at least a portion of the waste fluid carrying the displaced contaminants may be returned as a reject stream to a feed stock tank.

It should thus be appreciated that the valve system can run a first feed fluid past the upstream side of the filter in a first direction, and alternately run a second feed fluid past the upstream side of the filter in a second direction, and that the first and second feed streams can be the same or different streams. In preferred embodiments, the first and second feed streams derive at least in part from a common feed stream source.

In preferred embodiments of both FIGS. 1A and 1B, valves 120, 130, 170 are diverter valves. In especially preferred embodiments the valves are L-diverter valves, which advantageously minimizes dead space and pressure variations within system 100. In other embodiments, one or more of valves 120, 130, 170 can comprise any commercially suitable device for directing fluid flow including, for example, a ball valve, a knife valve, a gate valve, a pinch valve, and a solenoid valve. Other embodiments may incorporate a mixture of valve types.

Valves 120, 130, 170 can be motorized, which simplifies operation, and allows for automation, of the filtration system 100. In an especially preferred embodiment, filtration system 100 includes a controller configured to operate the valves 120, 130, 170 to perform filtration and filter cleaning operations as needed. In some embodiments, the filter cleaning process can be initiated at predetermined intervals.

As used herein, the term “valve system” is used in its broadest sense to mean one or more valves that can be operated independently or in concert to achieve a desired result. FIGS. 1A and 1B should be interpreted to include a valve system with at least one motorized L-diverter valve.

System 100 can optionally include one or more sensors or other monitors that transmit data to the controller that can be used to determine when to initiate the filter cleaning process. It is contemplated that such monitor may provide data related to the flow rate of the permeate, the optical density of the crude fluid mixture, pressure within the crossflow filter and/or within the lumen of the filter assembly, or other parameters related to filter efficiency. Thus, in such embodiments, the controller can automatically actuate valves 120 and 130 as needed to transition the system 100 into a filter cleaning operation from a filtration operation. It is especially preferred that such transition occurs automatically as necessary to maintain a desired flow-rate of permeate and/or other fluids within system 100. Component 180 should be interpreted as a combination sensor/controller.

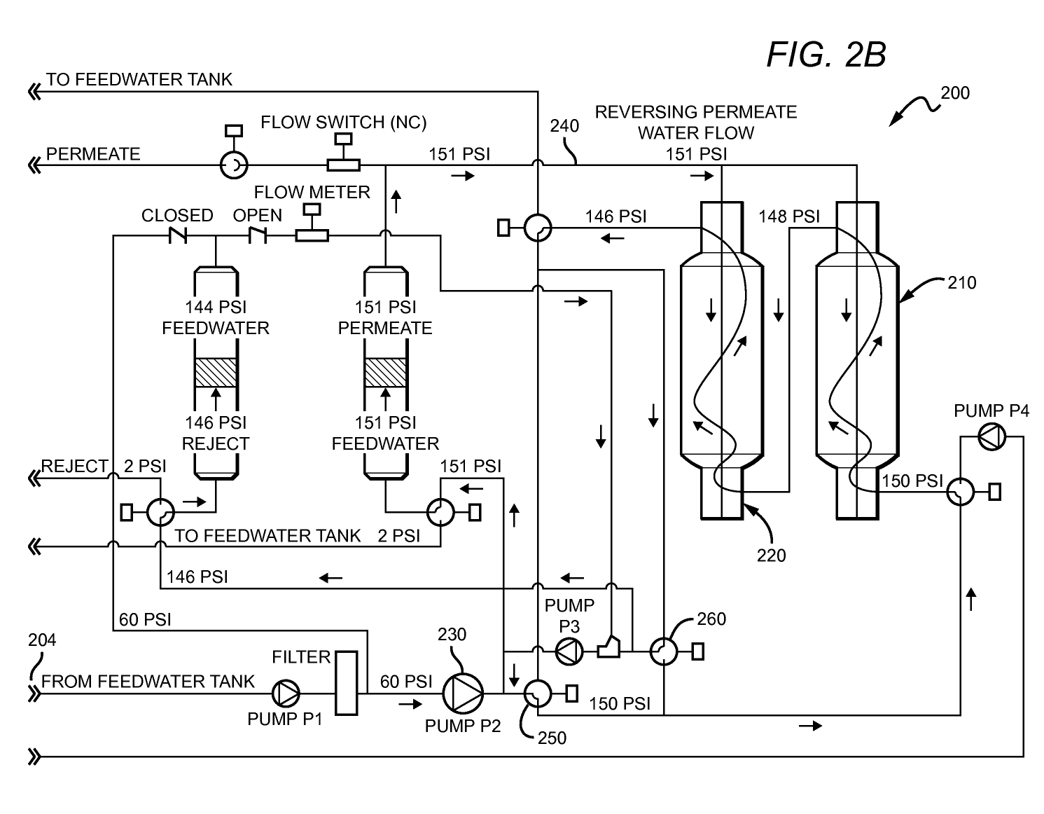

FIG. 2A illustrates another embodiment. Here, filtration system 200 has a pair of reverse osmosis (RO) filters 210, 220 arranged in series, which are configured to provide filtration of a pressurized feedwater stream 204 from a water reservoir or other source. Feedwater is supplied to a first crossflow filter 210 using a pump 230 and valve 250, and the reject stream or flow-by from the filter 210 can be directed as a pressurized feed stream to a second RO filter 220. The permeate stream from both filters 210, 220 exits through pressurived permeate line 240. System 200 can optionally include a positive displacement and energy recovery system such as that described in co-pending U.S. provisional application having Ser. No. 61/587,538 filed on Jan. 17, 2012.

FIG. 2B illustrates the filtration system 200, but configured to clean the filters 210 and 220. A pressurized feedwater stream is supplied to the second RO filter 220 using a pump 230 and valve 250; the reject stream from this RO filter 220 is directed as a pressurized feed stream to the first RO filter 210. The direction of fluid flow is thus reversed from that shown in FIG. 2A, thereby “sweeping” the surface of the filter media with a flow in a direction opposing that in which contaminants were deposited during filtration. A reversing permeate water flow can also be applied as a pressurized purging stream to the lumens of both RO filters via pressurized permeate line 240 at a pressure slightly higher than that of the feedwater flowing through the filters 210 and 220, providing a flow of fluid from the lumen to the flowing feedwater that dislodges fouling contaminants into the reject stream without disturbing or damaging the filter media.

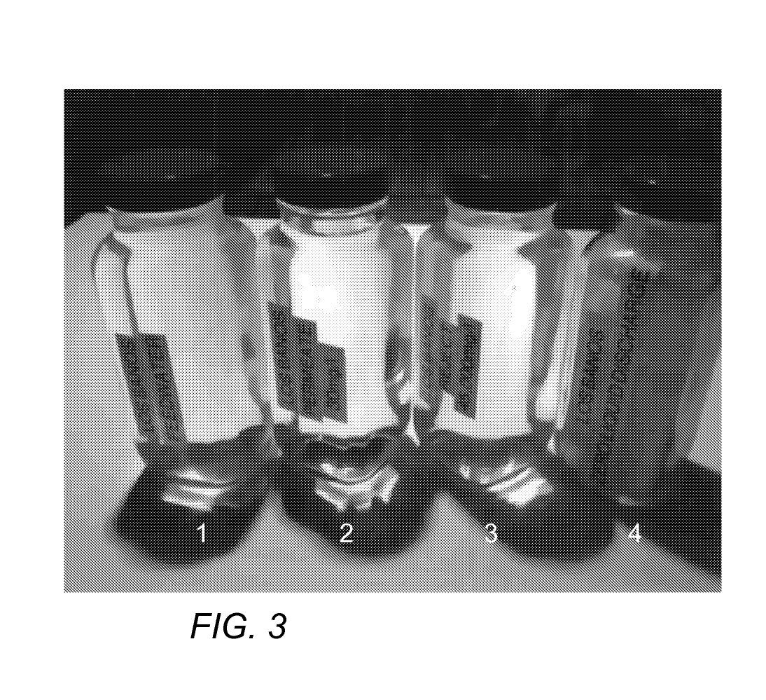

Results of filtration of crude feedwater using a filtration system as shown in FIGS. 2A-2B can be seen in FIG. 3. A series of samples taken from different stages of the filtration process are shown. Sample 1 represents the feedwater presented to the filtration system. In addition to discoloration from dissolved contaminants, fibrous materials can be seen in suspension. Sample 2 represents permeate obtained from the RO filters. There is no apparent discoloration or suspended solids. Sample 3 represents the reject fluid or flow-by after passing through the filters. Removal of permeate has concentrated the contaminants, resulting in a more pronounced discoloration than found in Sample 1. Sample 4 shows solid contaminants obtained by removing water from Sample 3, at least some of which advantageously can be sold for other uses.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An improved filtration system having a vessel and a filter element, a first port through which a feed stream can enter the vessel, a second port through which a reject stream can exit the vessel, and a third port through which a permeate can exit the vessel, the improvement comprises a valve system that can be configured to alternately pass the feed stream into the vessel through the first and second ports.

2. The filtration system of claim 1, wherein the filter element comprises a nanofiltration membrane.

3. The filtration system of claim 1, wherein the filter element comprises a spiral wound membrane.

4. The filtration system of claim 1, wherein the vessel is formed about the filter element.

5. The filtration system of claim 1, further comprising a pump configured to direct a backflush fluid in a reverse direction through the filter element.

6. The filtration system of claim 5, wherein the backflush fluid comprises an amount of the permeate.

7. The filtration system of claim 1, wherein the valve system comprises at least one motorized L-diverter valve.

8. The filtration system of claim 1, further comprising an energy recovery system that reduces a cost of operating the filtration system.

9. The filtration system of claim 8, wherein the energy recovery system comprises a positive displacement pump.

10. A method of modulating fouling of a filter disposed within a pressure vessel, the filter having an upstream side and a downstream side, comprising:
providing a valve system that can run a first feed fluid past the upstream side of the filter in a first direction, and alternately run a second feed fluid past the upstream side of the filter in a second direction; and
providing a control system configured to operate the valve system to run the first and second feed streams past the upstream side of the filter in the first and second directions, respectively.

11. The method of claim 10, wherein the first and second feed streams derive at least in part from a common feed stream source.

12. The method of claim 10, further comprising a sensor that provides information to the controller to assist in the controller in automatically operating the valve system.

13. The method of claim 10, further comprising the controller operating the valve system to backflush the filter.

14. The method of claim 10, further comprising the controller operating the valve system to backflush the filter using a portion of the permeate as a backflush fluid.

15. The method of claim 10, further comprising operating an energy recovery system that reduces a cost of operating the filter.

16. The method of claim 15, wherein the energy recovery system comprises a positive displacement pump.
